(19) United States
(12) Patent Application Publication
(10) Pub. No.: US 2026/0307353 A1
(43) Pub. Date: Oct. 8, 2026

(54) SYSTEMS AND METHODS OF MANUFACTURING COMPOSITE PARTS VIA STACKING

(71) Applicant: GE Vernova Infrastructure Technology LLC, Greenville, SC (US)

(72) Inventor: Stefaan Van Nieuwenhove, Enkhuizen (NL)

(21) Appl. No.: 19/480,487

(22) PCT Filed: May 3, 2023
(86) PCT No.: PCT/IB2023/054608

§ 371 Date: Oct. 31, 2025

(51) Int. Cl. B29D 99/00; B29K 101/12; B29K 105/08

(52) U.S. Cl. CPC B29D 99/0028; B29K 2101/12; B29K 2105/0872

(57) ABSTRACT

A method of manufacturing a composite part is provided. The method includes manufacturing a plurality of laminate layers (100) by integrating a fiber material (102) with a matrix material (104). The method also includes stacking the plurality of laminate layers (100) atop each other to form a stacked laminate (112) part. The method also includes applying a partial vacuum to the stacked laminate (112) part. The method also includes modifying a shape of the stacked laminate (112) part by allowing one or more of the plurality of laminate layers (100) to slide with respect to each other under the partial vacuum. The method also includes applying a full vacuum to the modified shape of the stacked laminate (112) part and heating the stacked laminate (112) part to fuse the plurality of laminate layers (100) together to manufacture the composite part.

### FIELD

The present disclosure relates generally to rotor blades, and more particularly to systems and methods for manufacturing composite parts via stacking that can be used to manufacture rotor blades.

### BACKGROUND

Wind power is considered one of the cleanest, most environmentally friendly energy sources presently available, and wind turbines have gained increased attention in this regard. A modern wind turbine typically includes a tower, a generator, a gearbox, a nacelle, and one or more rotor blades. The rotor blades capture kinetic energy of wind using known foil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

The rotor blades generally include a suction side shell and a pressure side shell typically manufactured using molding processes and then bonded together at bond lines along the leading and trailing edges of the blade. Further, the pressure and suction shells are relatively lightweight and have structural properties (e.g., stiffness, buckling resistance and strength) which are not configured to withstand the bending moments and other loads exerted on the rotor blade during operation. Thus, to increase the stiffness, buckling resistance and strength of the rotor blade, the body shell is typically reinforced using one or more structural components (e.g., opposing spar caps with a shear web configured therebetween).

The spar caps are typically constructed of various materials, including but not limited to glass fiber laminate composites and/or carbon fiber laminate composites. The shell of the rotor blade is generally built around the spar caps of the blade by stacking layers of fiber fabrics in a shell mold. The layers are then typically shaped and infused together with a resin.

As rotor blades continue to increase in size, conventional infusion processes, such as vacuum assisted resin transfer molding (VARTM), experience challenges for larger blade production (e.g., rotor blades exceeding 90 meters). Such challenges may include, for example, quality issues such as in-plane and/or out-of-plane wrinkling, damaged or broken fibers, locally separated layers of the fiber fabrics, and/or local changes to the fiber volume fraction due to matrix material movement. As a consequence, design safety margins need to be higher, especially as manufacturing costs increase. In addition, the ability to thermoform flat, fiber-reinforced reinforced laminates with a thermoplastic resin to form a three-dimensional object is limited due to the uncontrolled behavior of the fibers and stresses generated inside the laminate. This behavior becomes more severe with thicker laminates or when component parts having smaller radiuses are required.

As such, the art is continuously seeking new and improved methods for manufacturing composite parts that can be used to manufacture rotor blades and components thereof. Accordingly, the present disclosure is directed to systems and methods for manufacturing composite parts via stacking that can be used to manufacture rotor blades that address the aforementioned limitations.

### BRIEF DESCRIPTION

Aspects and advantages of the invention will be set forth in part in the following description, or may be obvious from the description, or may be learned through practice of the invention.

In one aspect, the present disclosure is directed to a method of manufacturing a composite part. The method includes manufacturing a plurality of laminate layers by integrating a fiber material with a matrix material. The method also includes stacking the plurality of laminate layers atop each other to form a stacked laminate part. The method also includes applying a partial vacuum to the stacked laminate part. The method also includes modifying a shape of the stacked laminate part by allowing one or more of the plurality of laminate layers to slide with respect to each other under the partial vacuum. The method also includes applying a full vacuum to the modified shape of the stacked laminate part and heating the stacked laminate part to fuse the plurality of laminate layers together to manufacture the composite part.

In an embodiment, the matrix material includes a thermoplastic resin.

In another embodiment, the partial vacuum includes a pressure of less than about one (1) bar.

In a further embodiment, the method further includes applying heat to the stacked laminate part before or while the shape of the stacked laminate part is modified.

In yet another embodiment, the heat applied is less than the glass transition temperature of the matrix material of the plurality of laminate layers.

In another further embodiment, the method further includes placing the stacked laminate part on an adaptable tool where the adaptable tool includes a surface that changes shape. Further, the step of modifying a shape of the stacked laminate part by allowing one or more of the plurality of laminate layers to slide with respect to each other under the partial vacuum includes changing the shape of the surface of the adaptable tool, thereby allowing the one or more of the plurality of laminate layers to slide with respect to each other under partial vacuum to form the shape.

In still another embodiment, the step of heating the stacked laminate part to fuse the plurality of laminate layers together to manufacture the composite part includes applying a heat above the glass transition temperature of the matrix material of the plurality of laminate layers.

In still a further embodiment, the method further includes placing the stacked laminate part within a vacuum unit.

In yet still another embodiment, the method further includes machining the plurality of laminate layers prior to stacking.

In still another further embodiment, the adaptable tool includes a radius of curvature less than the desired radius of curvature for the composite part.

In yet a further embodiment, the adaptable tool includes a radius of curvature greater than the desired radius of curvature for the composite part.

In still yet another embodiment, the method further includes applying an adhesive material or a core material between one or more of the plurality of laminate layers before the plurality of laminate layers are stacked atop each other.

In still yet a further embodiment, at least one of a top laminate layer or a bottom laminate layer of the plurality of laminate layers includes a different material providing a different surface than surfaces of inner laminate layers of the plurality of laminate layers.

In yet still a further embodiment, the different material includes a coating material.

In yet still another further embodiment, the different material includes an attachment location for a pre-manufactured part of a rotor blade, and the method further includes positioning the pre-manufactured part of the rotor blade with the plurality of laminate layers before the stacked laminate part is fused together.

In yet another further embodiment, the pre-manufactured part includes at least one of a patch, an attachment block, or a stiffener.

In still yet another further embodiment, the pre-manufactured part includes a profile having at least one of a tube-shape, angled-shape, L-shape, square-shape, or a T-shape.

In still yet further another embodiment, the composite part is part of a rotor blade.

In another aspect, the present disclosure is directed to a method for manufacturing a composite part. The method includes manufacturing a plurality of laminate layers of at least one fiber material and a matrix material. The method also includes stacking the plurality of laminate layers atop each other to form a stacked laminate part. The method also includes placing the stacked laminate part within a vacuum bag. The method also includes placing the vacuum bag on an adaptable tool. The method also includes providing a partial vacuum within the vacuum bag around the stacked laminate part. The method also includes modifying a shape of the stacked laminate part, via the adaptable tool, by allowing one or more of the plurality of laminate layers to slide with respect to each other under the partial vacuum. The method also includes applying a full vacuum to the modified shape of the stacked laminate part and heating the stacked laminate part to fuse the plurality of laminate layers together to manufacture the composite part.

In still another aspect, the present disclosure is directed to a system of manufacturing a composite part of a rotor blade. The system includes a plurality of laminate layers stacked atop each other to form a stacked laminate part, the plurality of laminate layers each including a fiber material and a matrix material. The system also includes a vacuum unit for applying a partial vacuum and a full vacuum to the stacked laminate part. The system also includes an adaptable tool for receiving the stacked laminate part where the adaptable tool includes a surface that changes shape, and the stacked laminate part changes shape when placed atop the adaptable tool and the surface of the adaptable tool changes shape by allowing one or more of the plurality of laminate layers to slide with respect to each other under partial vacuum. The system also includes a heating device configured to provide heat to the stacked laminate part to assist with modifying the shape of the stacked laminate part.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of an embodiment of a wind turbine according to the present disclosure;

FIG. 2 illustrates a perspective view of an embodiment of a rotor blade of a wind turbine according to the present disclosure;

FIG. 3 illustrates an exploded view of the modular rotor blade of FIG. 2;

FIG. 4 illustrates a cross-sectional view of an embodiment of a leading edge segment of a modular rotor blade according to the present disclosure;

FIG. 5 illustrates a cross-sectional view of an embodiment of a trailing edge segment of a modular rotor blade according to the present disclosure;

FIG. 6 illustrates a cross-sectional view of the modular rotor blade of FIG. 2 according to the present disclosure;

FIG. 7 illustrates a cross-sectional view of the modular rotor blade of FIG. 2 according to the present disclosure;

FIG. 8 illustrates a flow diagram of an embodiment of a method of manufacturing a composite part via stacking according to the present disclosure;

FIG. 9 illustrates a simplified diagram of an embodiment of a laminate according to the present disclosure;

FIG. 10 illustrates a simplified diagram of an embodiment of a laminate being machined according to the present disclosure;

FIGS. 11A-11B illustrate cross-sectional views of various embodiments of a stacked laminate part according to the present disclosure;

FIG. 12 illustrates a cross-sectional view of an embodiment of the stacked laminate part according to the present disclosure, particularly illustrating various surfaces, profiles, and core materials of the stacked laminate part;

FIG. 13 illustrates a simplified diagram of an embodiment of an adaptable tool having a plurality of laminate layers assembled thereon according to the present disclosure;

FIGS. 14A-14C illustrate simplified diagrams of an embodiment of a process of assembling and shaping laminate layers on an adaptable tool according to the present disclosure; and

FIGS. 15A-15B illustrate simplified diagrams of an embodiment of a process of assembling and forming laminate layers within a vacuum bag according to the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to systems and methods of manufacturing composite parts, such as parts of wind turbine rotor blades, using multiple laminate layers. The laminate layers can be manufactured by integrating a fiber material with a matrix material, such as a resin. Once manufactured, the laminate layers can then be stacked atop each other to form a stacked laminate part, and the stacked laminate part can be prepared for forming into the shape of the composite part. An example of preparing the stacked laminate part may include placing a partial vacuum around the stacked laminate part to help control the movement of the individual laminate layers of the stacked laminate part.

Once prepared, the stacked laminate part can then be modified into a desired shape for the composite part, and then the desired shape can be set by fusing the individual laminate layers together. For example, the final shape may be set by applying a full vacuum and heat to the stacked laminate part. Further, the composite part can be used in a variety of applications, such as in manufacturing a wind turbine rotor blade. However, it should be understood that the process and the composite parts produced from such a process described herein may also be used in a number of applications. For example, the process and the composite parts produced from such a process may be used as rotor blades in other applications, parts in watercraft, and/or parts in aircraft.

Thus, the systems and methods described herein provide many advantages not present in the prior art. For example, the systems and methods allow for thinner laminate layers to be used to form composite parts than those previously available. By utilizing multiple thinner laminate layers, the behavior of the fibers of the laminate layers may be more readily controlled when forming the composite part. Further, various quality issues associated with conventional thicker laminate layers may be avoided. Specifically, the present disclosure avoids the issues of in-plane and/or out-of-plane wrinkling, damaged or broken fibers, locally separated layers of the fiber fabrics, and local changes to the fiber volume fraction due to matrix material movement. This advantage is especially evident when compared to laminate layers with higher thicknesses or composite parts that require small radii of curvature. Furthermore, by utilizing multiple thinner laminate layers as described herein, the individual laminate layers may be more easily customized based on the desired application of the composite part. For example, the size, shape, fiber orientations, fiber volume fraction, or fiber materials may vary between individual laminate layers, thereby optimizing the mechanical properties for the particular application. This optimization may also result in composite parts with a lower total mass which is especially beneficial in the field of wind turbine rotor blades.

Moreover, unlike conventional methods of producing composite parts, the laminate layers of the present disclosure can be prefabricated and stacked together in a separate step(s). By performing these steps separately, the processing time related to the formation of the laminate layers into a desired shape is reduced when compared to conventional methods.

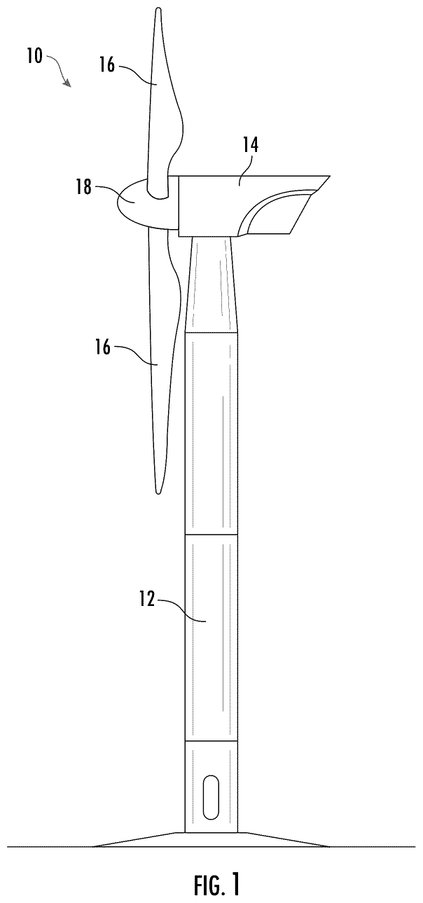

Referring now to the drawings, FIG. 1 illustrates one embodiment of a wind turbine 10 according to the present disclosure. As shown, the wind turbine 10 includes a tower 12 with a nacelle 14 mounted thereon. A plurality of rotor blades 16 are mounted to a rotor hub 18, which is in turn connected to a main flange that turns a main rotor shaft. The wind turbine power generation and control components are housed within the nacelle 14. The view of FIG. 1 is provided for illustrative purposes only to place the present invention in an exemplary field of use. It should be appreciated that the invention is not limited to any particular type of wind turbine configuration. In addition, the present invention is not limited to use with wind turbines, but may be utilized in any application using resin materials. Further, the methods described herein may also apply to manufacturing any similar structure that benefits from the resin formulations described herein.

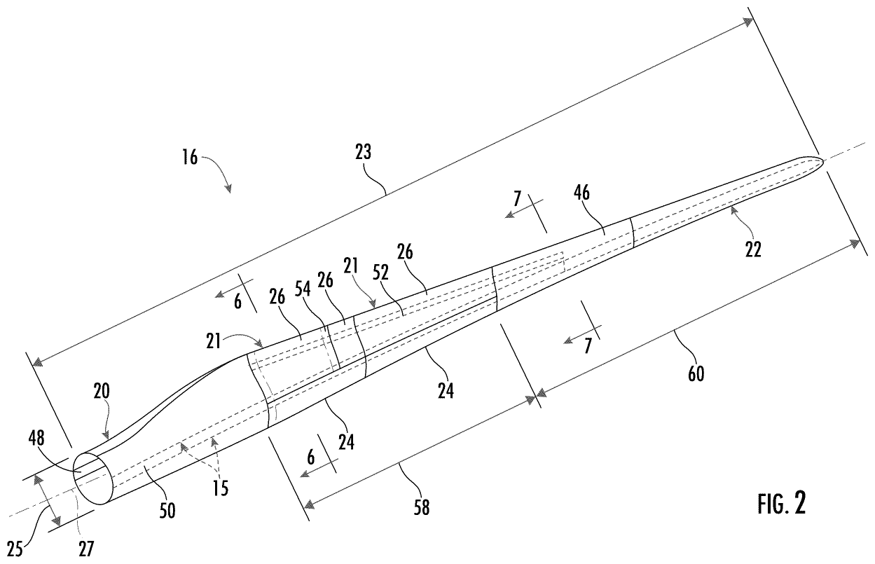

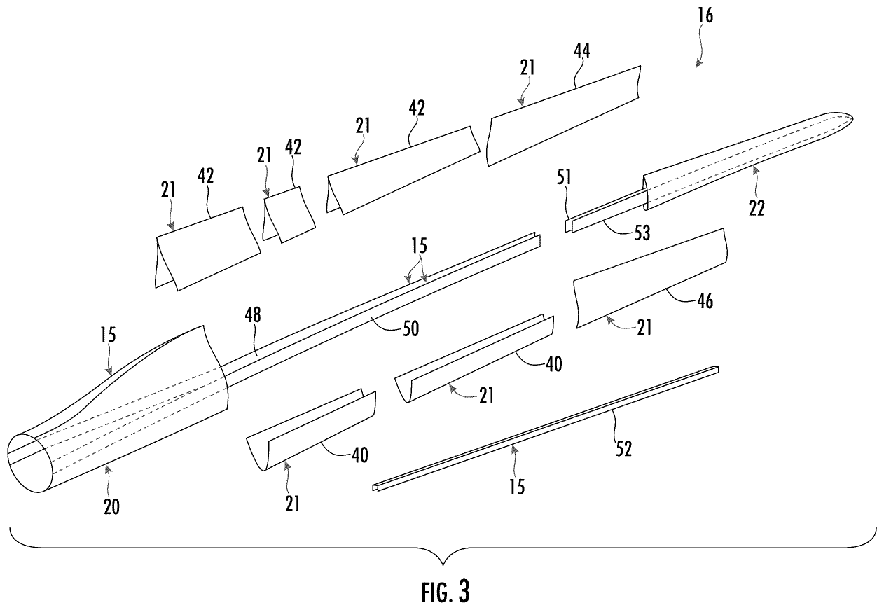

Referring now to FIGS. 2 and 3, various views of a rotor blade 16 according to the present disclosure are illustrated. As shown, the illustrated rotor blade 16 has a segmented or modular configuration. It should also be understood that the rotor blade 16 may include any other suitable configuration now known or later developed in the art. As shown, the modular rotor blade 16 includes a main blade structure 15 and at least one blade segment 21 secured to the main blade structure 15. More specifically, as shown, the rotor blade 16 includes a plurality of blade segments 21.

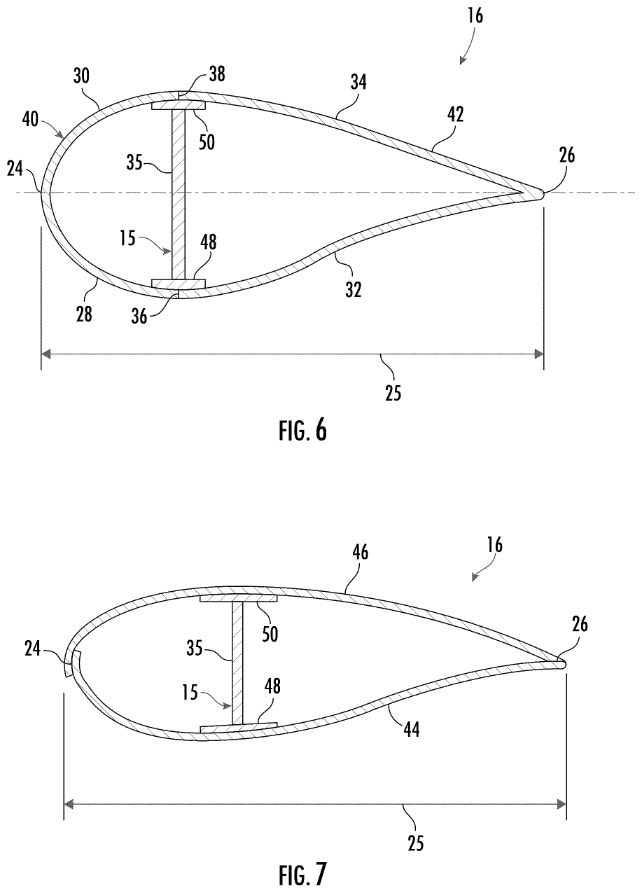

More specifically, as shown, the main blade structure 15 may include any one of or a combination of the following: a pre-formed blade root section 20, a preformed blade tip section 22, one or more one or more continuous spar caps 48, 50, 51, 53, one or more shear webs 35 (FIGS. 6-7), an additional structural component 52 secured to the blade root section 20, and/or any other suitable structural component of the rotor blade 16. Further, the blade root section 20 is configured to be mounted or otherwise secured to the rotor 18 (FIG. 1). In addition, as shown in FIG. 2, the rotor blade 16 defines a span 23 that is equal to the total length between the blade root section 20 and the blade tip section 22. As shown in FIGS. 2 and 6, the rotor blade 16 also defines a chord 25 that is equal to the total length between a leading edge 24 of the rotor blade 16 and a trailing edge 26 of the rotor blade 16. As is generally understood, the chord 25 may generally vary in length with respect to the span 23 as the rotor blade 16 extends from the blade root section 20 to the blade tip section 22.

Referring particularly to FIGS. 2-4, any number of blade segments 21 or panels (also referred to herein as blade shells) having any suitable size and/or shape may be generally arranged between the blade root section 20 and the blade tip section 22 along a longitudinal axis 27 in a generally span-wise direction. Thus, the blade segments 21 generally serve as the outer casing/covering of the rotor blade 16 and may define a substantially aerodynamic profile, such as by defining a symmetrical or cambered airfoil-shaped cross-section.

In additional embodiments, it should be understood that the blade segment portion of the blade 16 may include any combination of the segments described herein and are not limited to the embodiment as depicted. More specifically, in certain embodiments, the blade segments 21 may include any one of or combination of the following: pressure and/or suction side segments 44, 46, (FIGS. 2 and 3), leading and/or trailing edge segments 40, 42 (FIGS. 2-6), a non-jointed segment, a single-jointed segment, a multi-jointed blade segment, a J-shaped blade segment, or similar.

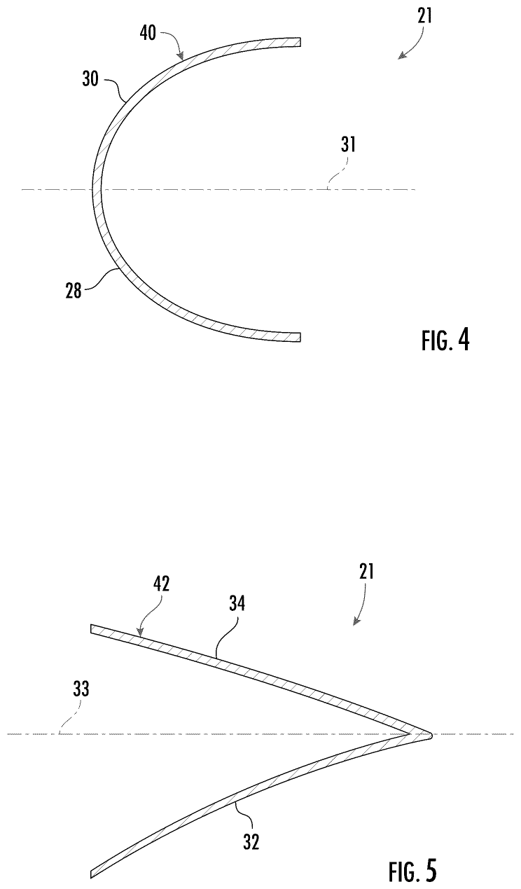

More specifically, as shown in FIG. 4, the leading edge segments 40 may have a forward pressure side surface 28 and a forward suction side surface 30. Similarly, as shown in FIG. 5, each of the trailing edge segments 42 may have an aft pressure side surface 32 and an aft suction side surface 34. Thus, the forward pressure side surface 28 of the leading edge segment 40 and the aft pressure side surface 32 of the trailing edge segment 42 generally define a pressure side surface of the rotor blade 16. Similarly, the forward suction side surface 30 of the leading edge segment 40 and the aft suction side surface 34 of the trailing edge segment 42 generally define a suction side surface of the rotor blade 16. In addition, as particularly shown in FIG. 6, the leading edge segment(s) 40 and the trailing edge segment(s) 42 may be joined at a pressure side seam 36 and a suction side seam 38. For example, the blade segments 40, 42 may be configured to overlap at the pressure side seam 36 and/or the suction side seam 38. Further, as shown in FIG. 2, adjacent blade segments 21 may be configured to overlap at a seam 54. Alternatively, in certain embodiments, the various segments of the rotor blade 16 may be secured together via an adhesive (or mechanical fasteners) configured between the overlapping leading and trailing edge segments 40, 42 and/or the overlapping adjacent leading or trailing edge segments 40, 42.

In specific embodiments, as shown in FIGS. 2-3 and 6-7, the blade root section 20 may include one or more longitudinally extending spar caps 48, 50 integrated therewith. For example, the blade root section 20 may be configured according to U.S. application Ser. No. 14/753, 155 filed Jun. 29, 2015, entitled “Blade Root Section for a Modular Rotor Blade and Method of Manufacturing Same” which is incorporated herein by reference in its entirety.

Similarly, the blade tip section 22 may include one or more longitudinally extending spar caps 51, 53 integrated therewith. More specifically, as shown, the spar caps 48, 50, 51, 53 may be configured to be engaged against opposing inner surfaces of the blade segments 21 of the rotor blade 16. Further, the blade root spar caps 48, 50 may be configured to align with the blade tip spar caps 51, 53. Thus, the spar caps 48, 50, 51, 53 may generally be designed to control the bending stresses and/or other loads acting on the rotor blade 16 in a generally span-wise direction (a direction parallel to the span 23 of the rotor blade 16) during operation of a wind turbine 10. In addition, the spar caps 48, 50, 51, 53 may be designed to withstand the span-wise compression occurring during operation of the wind turbine 10. Further, the spar cap(s) 48, 50, 51, 53 may be configured to extend from the blade root section 20 to the blade tip section 22 or a portion thereof. Thus, in certain embodiments, the blade root section 20 and the blade tip section 22 may be joined together via their respective spar caps 48, 50, 51, 53.

Referring to FIGS. 6-7, one or more shear webs 35 may be configured between the one or more spar caps 48, 50, 51, 53. More particularly, the shear web(s) 35 may be configured to increase the rigidity in the blade root section 20 and/or the blade tip section 22. Further, the shear web(s) 35 may be configured to close out the blade root section 20.

In addition, as shown in FIGS. 2 and 3, the additional structural component 52 may be secured to the blade root section 20 and extend in a generally span-wise direction so as to provide further support to the rotor blade 16. For example, the structural component 52 may be configured according to U.S. application Ser. No. 14/753,150 filed Jun. 29, 2015, entitled “Structural Component for a Modular Rotor Blade” which is incorporated herein by reference in its entirety. More specifically, the structural component 52 may extend any suitable distance between the blade root section 20 and the blade tip section 22. Thus, the structural component 52 is configured to provide additional structural support for the rotor blade 16 as well as an optional mounting structure for the various blade segments 21 as described herein. For example, in certain embodiments, the structural component 52 may be secured to the blade root section 20 and may extend a predetermined span-wise distance such that the leading and/or trailing edge segments 40, 42 can be mounted thereto.

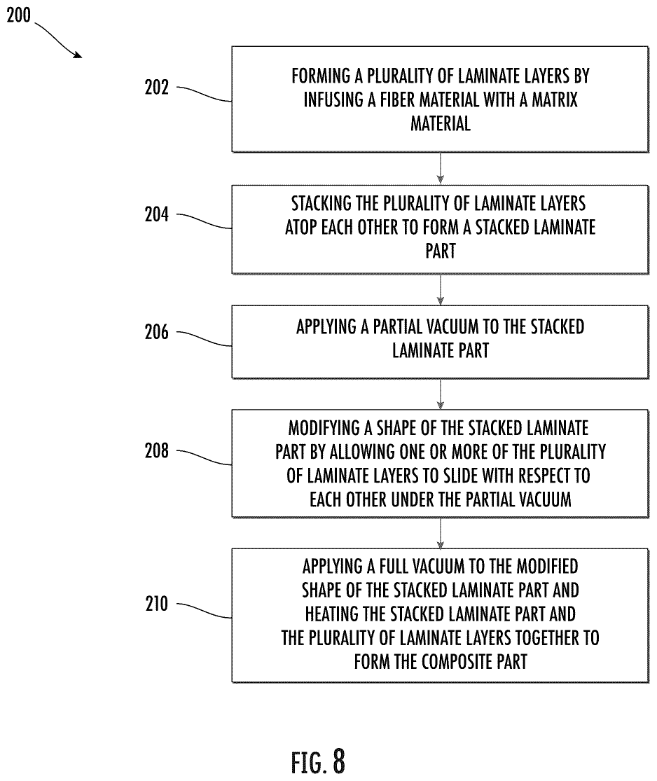

Referring now to FIG. 8, a flow diagram of a method 200 of manufacturing a composite part is illustrated according to the present disclosure. It should be understood that the method 200 may be used to manufacture the laminate layers 100 described herein. Though FIG. 8 depicts steps performed in a particular order for purposes of illustration and discussion, those of ordinary skill in the art, using the disclosures provided herein, will understand that various steps of the method 200 or any of the methods disclosed herein, may be adapted, modified, rearranged, performed simultaneously, or modified in various ways without deviating from the scope of the present disclosure.

As shown at (202), the method 200 includes manufacturing a plurality of laminate layers by integrating a fiber material with a matrix material. As shown at (204), the method 200 includes stacking the plurality of laminate layers atop each other to form a stacked laminate part. As shown at (206), the method 200 includes applying a partial vacuum to the stacked laminate part. As shown at (208), the method 200 includes modifying a shape of the stacked laminate part by allowing one or more of the plurality of laminate layers to slide with respect to each other under the partial vacuum. As shown at (210), the method 200 includes applying a full vacuum to the modified shape of the stacked laminate part and heating the stacked laminate part to fuse the plurality of laminate layers together to form the composite part.

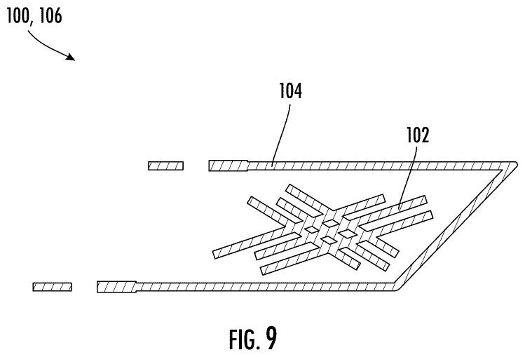

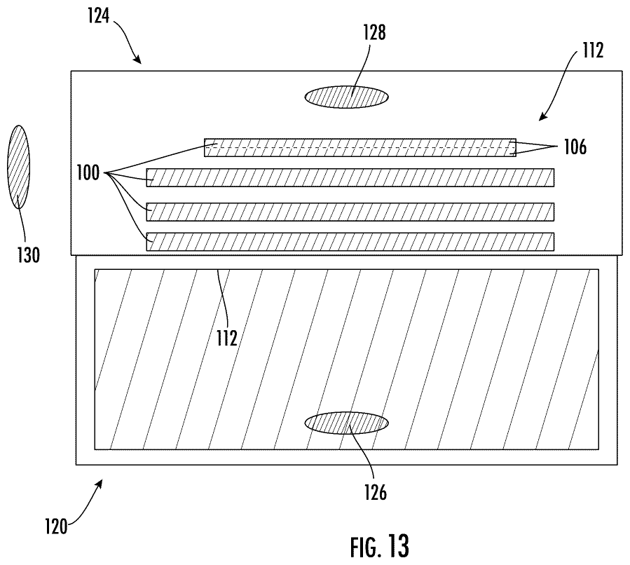

Thus, the method 200 of FIG. 8 can be better understood with respect to FIGS. 9-15B. In particular, FIG. 9 illustrates a simplified diagram of an embodiment of one of the laminate layers according to the present disclosure. As shown, the laminate layer 100 is constructed of a fiber material 102 with a matrix material 104. It should be understood that the laminate layers 100 described herein may include one or more layers produced from the fiber material 102 and the matrix material 104, respectively. For example, in an embodiment, each of the laminate layers 100 may include a single layer 106 (see e.g., the middle or bottom laminate layers 100 in FIG. 13) or multiple layers 106 (see e.g., the top laminate layer 100 in FIG. 13).

In additional embodiments, each of the laminate layers 100 may include different fiber materials 102. For example, a first laminate layer 100 may have a fiber length that is greater or smaller than another fiber material 102 in another laminate layer 100. In another embodiment, the shape of the fiber material 102 in a first laminate layer 100 may differ from the shape of a fiber material 102 in another laminate layer 100. Specifically, in an embodiment, a first laminate layer 100 may have a fiber material 102 of a smaller width or length than fiber materials of another laminate layer 100. In another example, the fiber volume fraction of a first laminate layer 100 may differ from the fiber volume fraction of another laminate layer 100. In particular, a first laminate layer 100 may have a greater or lesser volume of fiber material 102 per the total volume of the laminate layer 100 when compared to another laminate layer 100.

In another embodiment, the fiber orientations may differ between individual laminate layers 100. Specifically, in an embodiment, a first laminate layer 100 may include multi-axial, unidirectional, biaxial, or triaxial fiber orientations while another laminate layer 100 includes a different fiber orientation. In further embodiments, the fiber material 102 of a first laminate layer 100 may differ from another laminate layer 100. For example, glass fibers, carbon fibers, polymer fibers, wood fibers, bamboo fibers, ceramic fibers, nanofibers, metal fibers, or combinations may be used for a first laminate layer 100 while a different fiber material 102 may be used for another laminate layer 100.

The fiber material(s) 102 described herein may include, but is not limited to glass fibers, carbon fibers, polymer fibers, wood fibers, bamboo fibers, ceramic fibers, nanofibers, metal fibers, or combinations thereof. In addition, the direction of the fibers may include multi-axial, unidirectional, biaxial, triaxial, or any other another suitable direction and/or combinations thereof. In particular embodiments, for example, the fiber material 102 may contain predominantly unidirectional fibers. In further embodiments, the fiber material 102 may include woven or non-woven multi-axial fibers. In further embodiments, the fiber materials 102 may include fibers with a continuous length which span the entire length of a laminate layer 100. In additional embodiments, the fiber materials 102 may include relatively long fibers, such as greater than about 10 millimeters (mm), more preferably about 15 mm, and still more preferably about 20 mm.

In further embodiments, the matrix material 104 may be a resin material, such as a thermoplastic material. In an embodiment, the thermoplastic materials as described herein generally encompass a plastic material or polymer that is reversible in nature. For example, thermoplastic materials typically become pliable or moldable when heated to a certain temperature and returns to a more rigid state upon cooling.

Further, thermoplastic materials may include amorphous thermoplastic materials and/or semi-crystalline thermoplastic materials. Exemplary semi-crystalline thermoplastic materials may generally include, but are not limited to polyolefins, polyamides, fluoropolymer, ethyl-methyl acrylate, polyesters, polycarbonates, and/or acetals. More specifically, exemplary semi-crystalline thermoplastic materials may include poly(butylene terephthalate) (PBT), poly(ethylene terephthalate) (PET), polytrimethylene terephthalate (PTT), polypropylene, poly(phenyl sulfide), polyethylene, polyamide (nylon), polyetherketone, or any other suitable semi-crystalline thermoplastic material.

Amorphous thermoplastic materials as described herein generally encompass a plastic material or polymer that is reversible in nature. For example, amorphous thermoplastic materials typically become pliable or moldable when heated to a certain temperature and returns to a more rigid state upon cooling. Some example amorphous thermoplastic materials may generally include, but are not limited to, styrenes, vinyls, cellulosics, polyesters, acrylics, polysulfones, and/or imides. More specifically, exemplary amorphous thermoplastic materials may include polystyrene, acrylonitrile butadiene styrene (ABS), poly(methyl methacrylate) (PMMA), polyethylene terephthalate glycol (PETG), polycarbonate, poly(vinyl acetate), amorphous polyamide, poly(vinyl chloride) (PVC), poly(vinylidene chloride), polyurethane, or any other suitable amorphous thermoplastic material.

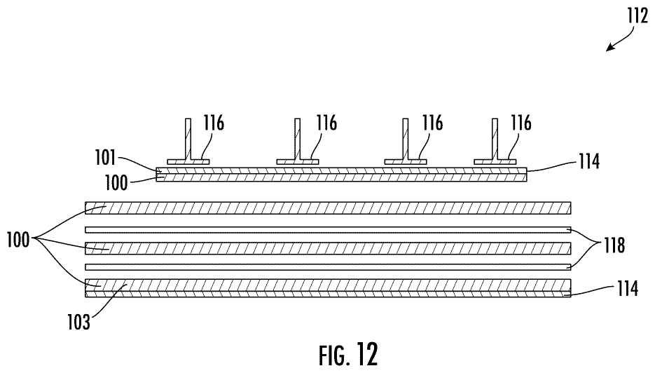

However, the resin material may also include a thermoset material. The thermoset materials as described herein generally encompass a plastic material or polymer that is non-reversible in nature. For example, thermoset materials, once cured, cannot be easily remolded, or returned to a liquid state. As such, after initial forming, thermoset materials are generally resistant to heat, corrosion, and/or creep. Example thermoset materials may generally include, but are not limited to, some polyesters, some polyurethanes, esters, epoxies, or any other suitable thermoset material. If a thermoset material is selected as the matrix material 104, bonding between laminate layers 100 may be enhanced by providing a material such as a core material. (see e.g., FIG. 12).

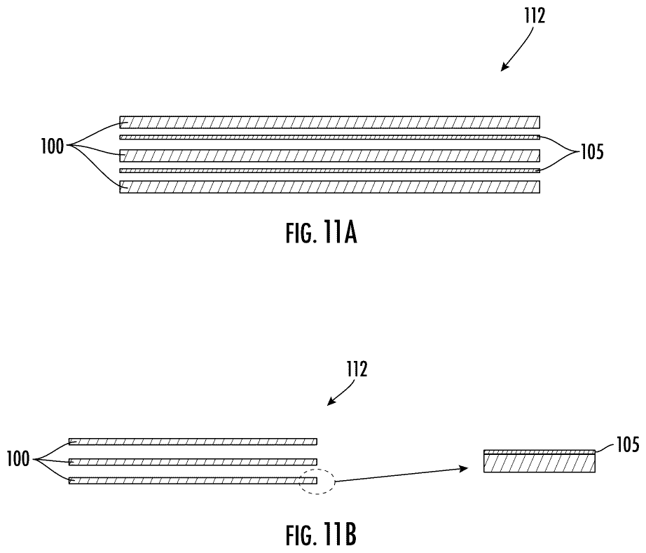

Once the fiber material 102 and the matrix material 104 are selected, the fiber and matrix materials 102, 104 may be integrated together to manufacture the laminate layer 100. Accordingly, in an embodiment, a plurality of laminate layers 100 can be manufactured and stacked together to form a stacked laminate part 112. (see e.g., FIGS. 11-15B).

By varying the number of laminate layers 100 within the stacked laminate part 112 and/or the properties of the laminate layers 100, the stacked laminate part 112 can be easily tailored to satisfy specific requirements or specifications for various wind turbine components. For example, if it is known that a particular region of the stacked laminate part 112 will experience a higher amount of mechanical stress than other regions of the part (e.g., due to its location on the rotor blade), the properties of that region may be tailored by providing distinct laminate layers 100 in that region. In addition, if production methods of the stacked laminate part 112 have specific properties, specific laminate layers 100 may be chosen to meet those properties.

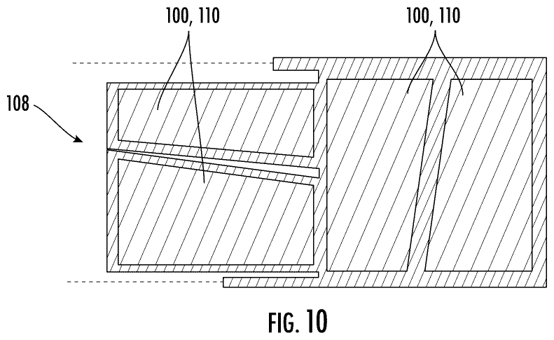

Referring now to FIG. 10, a top view of an embodiment of a plurality of laminate layers 100 arranged on a machining table 108 is illustrated according to the present disclosure. Thus, in an embodiment, as shown, the laminate layers 100 can be machined prior to being used in the production of the composite part and arranged on the table for subsequent joining. For example, in an embodiment, the laminate layers 100 can be placed on the machining table 108 such as a cutting table, and machined into a particular shape. More specifically, in an embodiment, the laminate layers 100 can be cut into individual pieces 110 that can be used as individual laminate layers 100 to produce a composite part. These pieces 110 may be arranged on the machining table 108 in preparation for how the pieces 110 could be arranged on an adaptable tool for shaping. For instance, if laminate layers 100 have an asymmetrical orientation when stacked together (see e.g., FIGS. 12-14C), the orientation of this asymmetrical stack may be arranged on the machining table 108 in preparation for stacking on an adaptable tool. Alternatively, the individual pieces 110 may be separated and used as laminate layers 100 to produce multiple composite parts.

Referring now to FIGS. 11A-11B, cross-sectional views of various embodiments of the stacked laminate part 112 according to the present disclosure are illustrated. As shown in FIG. 11A, the stacked laminate part 112 includes the laminate layers 100 having a layer of an adhesive material 105, such as a resin, arranged between the individual laminate layers 100. In another example, as shown in FIG. 11B, the stacked laminate part 112 includes the laminate layers 100 having the adhesive material 105 deposited directly onto the surface of the laminate layers 100 before the laminate layers 100 are stacked together. As shown, the adhesive material 105 may be applied between each of the laminate layers 100. However, the adhesive material 105 may also be applied only between some of the layers of laminate layers 100. Regardless of whether the adhesive material 105 is deposited as a layer or directly on a surface of the laminate layers 100, adhesive material 105 would further help with the bonding of the individual laminate layers 100 in addition to the matrix material 104 used to manufacture the individual laminate layers 100.

Referring now to FIG. 12, a cross-sectional view of an embodiment of the stacked laminate part 112 is illustrated according to the present disclosure, particularly illustrating various surfaces, profiles, and core materials of the stacked laminate part 112. As shown, the stacked laminate part 112 includes a top laminate layer 101 and a bottom laminate layer 103, at least one of which has a different material 114 that provides a different surface than surfaces of the inner laminate layers 100 of the stacked laminate part 112. For example, in an embodiment, the different material 114 may be an erosion-resistant material, such as a coating material.

In addition, as shown, the stacked laminate part 112 may include one or more additional components 116 that can be attached to the top and/or bottom laminate layers 100. For example, in an embodiment, the additional components 116 may include a pre-manufactured part of the rotor blade 16, such as a patch, an attachment block, or a stiffener. The pre-manufactured part may also be a pre-formed blade root section 20, a pre-formed blade tip section 22, one or more one or more continuous spar caps 48, 50, 51, 53, one or more shear webs 35 (FIGS. 6-7), an additional structural component 52 secured to the blade root section 20, and/or any other suitable structural component of the rotor blade 16. The additional components 116 may also have a general shape required for a particular application, such as a tube-shape, angled-shape, L-shape, square-shape, or a T-shape.

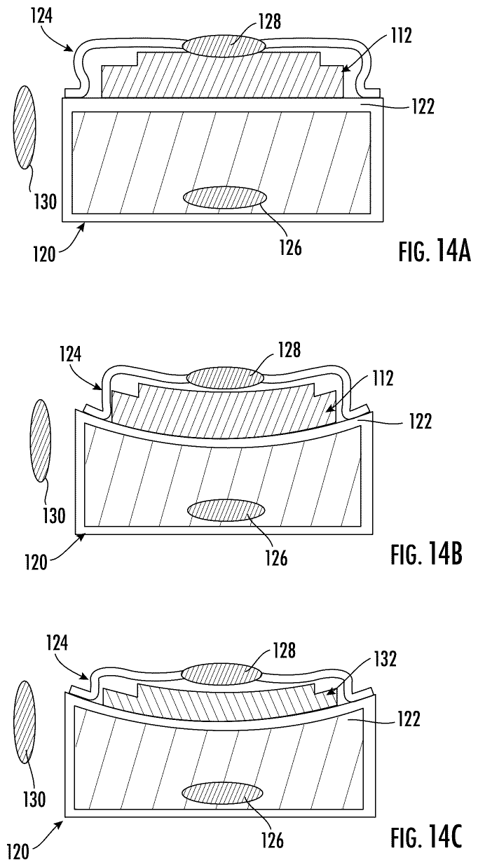

By providing the different materials and/or components 114, 116 prior to the shaping of the stacked laminate part 112, the different materials and/or components 114, 116 may be shaped and bonded with the stacked laminate part 112, thereby ensuring a bond between the stacked laminate part 112 and the different materials and/or components 114, 116 without any further needed production steps. Specifically, when the stacked laminate part 112 is shaped by an adaptable tool (see e.g., FIGS. 14A-14C) the different materials and/or components 114, 116 may also be shaped along with the stacked laminate part 112.

Still referring to FIG. 12, in addition to the different materials and/or components 114, 116, the stacked laminate part 112 may include one or more core materials 118 between one or more of the laminate layers 100. In such embodiments, the core material 118 is configured to assist with altering one or more mechanical properties of the composite part. Some examples of possible core materials 118 may include, for example, plastic, balsa, metal, foam, etc. The core materials 118 may also include materials with particular internal configurations such as a honeycomb framework. In an additional embodiment, the core material 118 may include an uncured thermoset material or a thermoplastic material. In such embodiments, the core materials 118 are configured to further tailor the composite part. Further, like the different materials and/or components 114, 116, providing the core materials 118 prior to forming the composite part may form a bond between the stacked laminate part 112 and the core materials 118 as a result of the core materials 118 being bonded with the stacked laminate part 112 without the need for any further production steps.

Referring now to FIG. 13, a simplified diagram of an embodiment of an adaptable tool 120 having a plurality of laminate layers 100 assembled thereon is depicted according to the present disclosure. As shown, the laminate layers 100 can be stacked together to form the stacked laminate part 112 and the part 112 can be placed atop the tool 120. Accordingly, the adaptable tool 120 is capable of modifying a shape of the stacked laminate part 112. Specifically, in an embodiment, the adaptable tool 120 may include a platform 122 that assists with moving the laminate layers 100 with respect to each other, as will be discussed in greater detail with reference to FIGS. 14A-14C.

Additional components can also be incorporated into or be provided with the adaptable tool 120 which can assist with the shaping and/or fusing of the composite part. For example, the adaptable tool 120 may include a vacuum unit 124 capable of providing a partial vacuum and/or a full vacuum around or to the stacked laminate part 112. Specifically, in an embodiment, a partial vacuum may include a pressure which is measured relative to atmospheric pressure. More specifically, in an embodiment, the partial vacuum may include a pressure that is less than about one (1) bar, such as less than about 0.95 bar, such as less than about 0.925 bar, such as less than about 0.9 bar. By providing a partial vacuum, the laminate layers 100 can move or slide with respect to each other in a controlled manner. This control enables greater accuracy and control over the mechanical properties when forming composite parts. Further, as mentioned, the vacuum unit 124 may also be capable of providing a full vacuum. Specifically, a full vacuum may include a pressure that is less than about 0.2 bar, such as less than 0.1 bar, such as less than 0.05 bar. By providing a full vacuum, the laminate layers 100 of the stacked laminate part 112 may be completely locked into place in preparation for fusing of the laminate layers 100 together.

Still referring to FIG. 13, the adaptable tool 120 may also include one or more heating elements 126, 128, 130. In particular, as shown, one of the heating elements 126, 128, 130 may be provided above, below, or on the side of the stacked laminate part to provide uniform heating to the stacked laminate part 112.

In addition, each of these heating elements 126, 128, 130 may be capable of providing various temperatures that are particularly advantageous when producing the composite part described herein. Specifically, in an embodiment, the heating elements 126, 128, 130 may be capable of providing a heat that is specific to the matrix material 104 of the laminate layers 100. More specifically, in an embodiment, the heating elements 126, 128, 130 may be capable of providing a heat less than the glass transition temperature of the matrix material 104 of the laminate layers 100. This lower temperature heat could be applied before or during the operation of the adaptable tool 120 and allow for the laminate layers 100 to move or slide while requiring less force be applied than would otherwise be required without the application of heat. Specifically, the shaping of the stacked laminate part 112 may be performed with less effort or mechanical force. The heating elements 126, 128, 130 may also be capable of providing a heat above the glass transition temperature of the matrix material 104 of the laminate layers 100. By providing a heat above the glass transition temperature, the laminate layers 100 may be fused together to form the composite part. Further, by providing a heat above the glass transition temperature, the stresses between the laminate layers 100 may be reduced. In an additional embodiment, if an adhesive material 105 is provided, the heat applied may be above the glass transition temperature of both the matrix material 104 of the laminate layers 100 and the adhesive material 105 applied between the laminate layers 100.

Referring now to FIGS. 14A-14C, simplified diagrams of an embodiment of a process of assembling and shaping laminate layers 100 on an adaptable tool 120 are shown according to the present disclosure. For example, in an embodiment, as shown as shown from FIG. 14A to FIG. 14B, the platform 122 of the adaptable tool 120 can change shape to allow the laminate layers 100 to move and/or slide with respect to each other, thereby forming the stacked laminate part 112 into a desired shape. During shaping, a partial vacuum and heat, e.g., below the glass transition, may be applied via either the vacuum unit 124 and/or the heating elements 126, 128, 130 to assist in controlling the shaping as desired.

More specifically, as shown in FIG. 14A, the adaptable tool 120 may begin with a flat, planar platform 122. Then, the platform 122 may be curved to a define a radius of curvature. As the platform 122 curves, the laminate layers 100 also curve with a similar radius of curvature to reach a desired shape. Thus, in certain embodiments, the selected shape for the platform 122 of the adaptable tool 120 may be the final shape of the composite part 132. Alternatively, the selected shape for the platform 122 of the adaptable tool 120 may include a radius of curvature less than or greater than the final desired radius of curvature for the composite part 132. Specifically, the radius of curvature of the platform 122 of the adaptable tool 120 may be about 0.5 to about 1.5 times the radius of curvature of the composite part 132. By orienting the platform 122 to have a shape less than or greater than the final desired radius of curvature for the composite part 132, shaping issues associated with thermoforming of laminate layers such as spring-back or spring-in may be mitigated. The platform 122 may also provide a variety of other shapes with their own radiuses of curvature similar to the radius of curvature as aforementioned.

Once the stacked laminate part 112 is modified to a desired shape, the pressure within the vacuum unit 124 may be decreased to provide a full vacuum as detailed above. By decreasing the pressure, the shape of the stacked laminate part 112 is secured in preparation for fusing. Once secured, as shown in FIG. 14C, heat above the glass transition temperature may be applied by one or more of the heating elements 126, 128, 130 to fuse the laminate layers 100 together to form the composite part 132. Once the composite part 132 is formed and the temperature of the composite part 132 has been reduced sufficiently, the composite part 132 can be removed from the adaptable tool 120 and used in the desired application (e.g., to manufacture a part of the rotor blade).

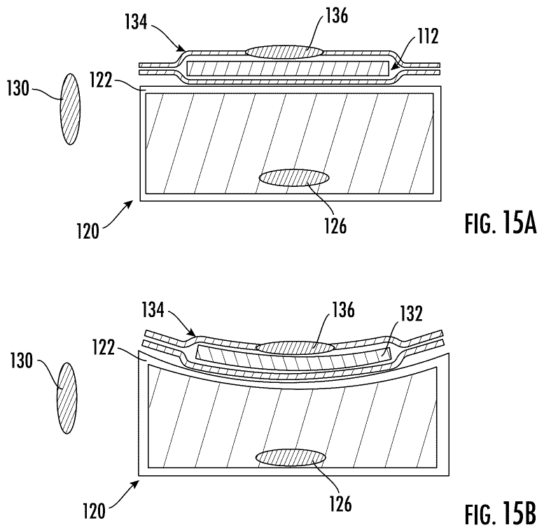

Referring now to FIGS. 15A-15B, simplified diagrams of an embodiment of a process of assembling and manufacturing laminate layers 100 within a vacuum bag 134 are illustrated according to the present disclosure. As shown, the formation of a composite part 132 may also be accomplished through the use of a vacuum bag 134. As depicted and described, a vacuum bag 134 may act as a mold or partition in which the stacked laminate 112 may be placed. The vacuum bag 134 may also be capable of acting as a vacuum unit capable of providing a partial of full vacuum similar to vacuum unit 124 described above. In addition, the vacuum bag 134 may be moveable between surfaces such as the machining table 108 or the adaptable tool 120 and provide more efficiency of movement of the stacked laminate part 112 when transitioning from the stacking and shaping steps of production.

To produce a composite part 132 using the vacuum bag 134, the vacuum bag 134 may be placed on the platform 122 of the adaptable tool 120. A partial vacuum may then be provided around the stacked laminate part 112 via the vacuum bag 134. The shape of the stacked laminate part 112 may then be modified by modifying the shape of the platform 122 of the adaptable tool 120 resulting in the laminate layers 100 sliding with respect to each other under the partial vacuum. For example, the vacuum bag 134 may be connected to the platform 122, and the vacuum bag 134 along with the stacked laminate part 112 may be stretched or modified to the shape the platform 122 takes when the adaptable tool 120 is operated. This shaping step may be similar to the shaping step depicted in FIGS. 14A-14B. Once shaped, a full vacuum may be applied via the vacuum bag 134 and the stacked laminate part 112 may be heated to fuse the laminate layers 100 with each other thereby forming the composite part 132 similar to the fusing step discussed in FIG. 13C. Once the composite part 132 is formed, the composite part 132 may be removed from the vacuum bag 134 and used in the desired application.

Various aspects and embodiments of the present disclosure are defined by the following numbered clauses:
Clause 1. A method of manufacturing a composite part, the method comprising:
manufacturing a plurality of laminate layers by integrating a fiber material with a matrix material;
stacking the plurality of laminate layers atop each other to form a stacked laminate part;
applying a partial vacuum to the stacked laminate part;
modifying a shape of the stacked laminate part by allowing one or more of the plurality of laminate layers to slide with respect to each other under the partial vacuum; and
applying a full vacuum to the modified shape of the stacked laminate part and heating the stacked laminate part to fuse the plurality of laminate layers together to manufacture the composite part.
Clause 2. The method of clause 1, wherein the matrix material comprises a thermoplastic resin.
Clause 3. The method of any of clauses 1-2, wherein the partial vacuum comprises a pressure of less than about one (1) bar.
Clause 4. The method of any of the preceding clauses, further comprising applying heat to the stacked laminate part before or while the shape of the stacked laminate part is modified.
Clause 5. The method of clause 4, wherein the heat applied is less than the glass transition temperature of the matrix material of the plurality of laminate layers.
Clause 6. The method of any of the preceding clauses, further comprising:
placing the stacked laminate part on an adaptable tool, wherein the adaptable tool comprises a surface that changes shape,
wherein modifying a shape of the stacked laminate part by allowing one or more of the plurality of laminate layers to slide with respect to each other under the partial vacuum further includes changing the shape of the surface of the adaptable tool, thereby allowing the one or more of the plurality of laminate layers to slide with respect to each other under partial vacuum to form the shape.
Clause 7. The method of any of the preceding clauses, wherein heating the stacked laminate part to fuse the plurality of laminate layers together to manufacture the composite part comprises applying a heat above the glass transition temperature of the matrix material of the plurality of laminate layers.
Clause 8. The method of any of the preceding clauses, further comprising placing the stacked laminate part within a vacuum unit.
Clause 9. The method of any of the preceding clauses, further comprising machining the plurality of laminate layers prior to stacking.
Clause 10. The method of any of clauses 6-9, wherein the adaptable tool comprises a radius of curvature less than the desired radius of curvature for the composite part.
Clause 11. The method of any of clauses 6-10, wherein the adaptable tool comprises a radius of curvature greater than the desired radius of curvature for the composite part.
12. The method of any of the preceding clauses, further comprising applying an adhesive material or a core material between one or more of the plurality of laminate layers before the plurality of laminate layers are stacked atop each other.
Clause 13. The method of any of the preceding clauses, wherein at least one of a top laminate layer or a bottom laminate layer of the plurality of laminate layers comprises a different material providing a different surface than surfaces of inner laminate layers of the plurality of laminate layers.
Clause 14. The method of clause 13, wherein the different material comprises a coating material.
Clause 15. The method of any of clauses 13-14, wherein the different material comprises an attachment location for a pre-manufactured part of a rotor blade, wherein the method further comprises positioning the pre-manufactured part of the rotor blade with the plurality of laminate layers before the stacked laminate part is fused together.
Clause 16. The method of clause 15, wherein the pre-manufactured part comprises at least one of a patch, an attachment block, or a stiffener.
Clause 17. The method of any of clauses 15-16, wherein the pre-manufactured part comprises a profile having at least one of a tube-shape, angled-shape, L-shape, square-shape, or a T-shape.

Clause 18. The method of any of the preceding clauses, wherein the composite part is part of a rotor blade.

Clause 19. A method for manufacturing a composite part, the method comprising:
manufacturing a plurality of laminate layers of at least one fiber material and a matrix material;
stacking the plurality of laminate layers atop each other to form a stacked laminate part;
placing the stacked laminate part within a vacuum bag;
placing the vacuum bag on an adaptable tool;
providing a partial vacuum within the vacuum bag around the stacked laminate part;
modifying a shape of the stacked laminate part, via the adaptable tool, by allowing one or more of the plurality of laminate layers to slide with respect to each other under the partial vacuum; and
applying a full vacuum to the modified shape of the stacked laminate part and heating the stacked laminate part to fuse the plurality of laminate layers together to manufacture the composite part.
Clause 20. A system of manufacturing a composite part of a rotor blade, the system comprising:
a plurality of laminate layers stacked atop each other to form a stacked laminate part, the plurality of laminate layers each comprising a fiber material and a matrix material;
a vacuum unit for applying a partial vacuum and a full vacuum to the stacked laminate part;
an adaptable tool for receiving the stacked laminate part, wherein the adaptable tool comprises a surface that changes shape, wherein the stacked laminate part changes shape when placed atop the adaptable tool and the surface of the adaptable tool changes shape by allowing one or more of the plurality of laminate layers to slide with respect to each other under partial vacuum; and
a heating device configured to provide heat to the stacked laminate part to assist with modifying the shape of the stacked laminate part.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method of manufacturing a composite part, the method comprising:
manufacturing a plurality of laminate layers by integrating a fiber material with a matrix material;
stacking the plurality of laminate layers atop each other to form a stacked laminate part;
applying a partial vacuum to the stacked laminate part;
modifying a shape of the stacked laminate part by allowing one or more of the plurality of laminate layers to slide with respect to each other under the partial vacuum; and
applying a full vacuum to the modified shape of the stacked laminate part and heating the stacked laminate part to fuse the plurality of laminate layers together to manufacture the composite part.

2. The method of claim 1, wherein the matrix material comprises a thermoplastic resin.

3. The method of claim 1, wherein the partial vacuum comprises a pressure of less than about one (1) bar.

4. The method of claim 1, further comprising applying heat to the stacked laminate part before or while the shape of the stacked laminate part is modified.

5. The method of claim 4, wherein the heat applied is less than the glass transition temperature of the matrix material of the plurality of laminate layers.

6. The method of claim 1, further comprising:
placing the stacked laminate part on an adaptable tool, wherein the adaptable tool comprises a surface that changes shape,
wherein modifying a shape of the stacked laminate part by allowing one or more of the plurality of laminate layers to slide with respect to each other under the partial vacuum further includes changing the shape of the surface of the adaptable tool, thereby allowing the one or more of the plurality of laminate layers to slide with respect to each other under partial vacuum to form the shape.

7. The method of claim 1, wherein heating the stacked laminate part to fuse the plurality of laminate layers together to manufacture the composite part comprises applying a heat above the glass transition temperature of the matrix material of the plurality of laminate layers.

8. The method of claim 1, further comprising placing the stacked laminate part within a vacuum unit.

9. The method of claim 1, further comprising machining the plurality of laminate layers prior to stacking.

10. The method of claim 6, wherein the adaptable tool comprises a radius of curvature less than the desired radius of curvature for the composite part.

11. The method of claim 6, wherein the adaptable tool comprises a radius of curvature greater than the desired radius of curvature for the composite part

12. The method of claim 1, further comprising applying an adhesive material or a core material between one or more of the plurality of laminate layers before the plurality of laminate layers are stacked atop each other.

13. The method of claim 1, wherein at least one of a top laminate layer or a bottom laminate layer of the plurality of laminate layers comprises a different material providing a different surface than surfaces of inner laminate layers of the plurality of laminate layers.

14. The method of claim 13, wherein the different material comprises a coating material.

15. The method of claim 13, wherein the different material comprises an attachment location for a pre-manufactured part of a rotor blade, wherein the method further comprises positioning the pre-manufactured part of the rotor blade with the plurality of laminate layers before the stacked laminate part is fused together.

16. The method of claim 15, wherein the pre-manufactured part comprises at least one of a patch, an attachment block, or a stiffener.

17. The method of claim 15, wherein the pre-manufactured part comprises a profile having at least one of a tube-shape, angled-shape, L-shape, square-shape, or a T-shape.

18. The method of claim 1, wherein the composite part is part of a rotor blade.

19. A method for manufacturing a composite part, the method comprising:
manufacturing a plurality of laminate layers of at least one fiber material and a matrix material;
stacking the plurality of laminate layers atop each other to form a stacked laminate part;
placing the stacked laminate part within a vacuum bag ;
placing the vacuum bag on an adaptable tool;
providing a partial vacuum within the vacuum bag around the stacked laminate part;
modifying a shape of the stacked laminate part, via the adaptable tool, by allowing one or more of the plurality of laminate layers to slide with respect to each other under the partial vacuum; and
applying a full vacuum to the modified shape of the stacked laminate part and heating the stacked laminate part to fuse the plurality of laminate layers together to manufacture the composite part.

20. A system of manufacturing a composite part of a rotor blade, the system comprising:
a plurality of laminate layers stacked atop each other to form a stacked laminate part, the plurality of laminate layers each comprising a fiber material and a matrix material;
a vacuum unit for applying a partial vacuum and a full vacuum to the stacked laminate part;
an adaptable tool for receiving the stacked laminate part, wherein the adaptable tool comprises a surface that changes shape, wherein the stacked laminate part changes shape when placed atop the adaptable tool and the surface of the adaptable tool changes shape by allowing one or more of the plurality of laminate layers to slide with respect to each other under partial vacuum; and
a heating device configured to provide heat to the stacked laminate part to assist with modifying the shape of the stacked laminate part.
